(19) United States
(12) Patent Application Publication
(10) Pub. No.: US 2026/0283394 A1
(43) Pub. Date: Sep. 24, 2026

(54) BEVERAGE MAKING ASSEMBLY

(71) Applicant: HCL Technologies Limited, New Delhi (IN)

(72) Inventors: Akash Mohan Salunkhe, Satara (IN); Yuvaraj D Patil, Kolhapur (IN)

(21) Appl. No.: 19/411,449

(22) Filed: Dec. 8, 2025

(30) Foreign Application Priority Data
Mar. 20, 2025 (IN) 202511025377

(51) Int. Cl. A47J 31/40; A47J 31/41; A47J 31/46; B65D 47/20

(52) U.S. Cl. CPC A47J 31/407; A47J 31/41; A47J 31/461; A47J 31/468; A47J 31/469; B65D 47/2018

(57) ABSTRACT

A beverage making assembly is disclosed. The beverage making assembly includes a retractable-flavor storage. The retractable-flavor storage includes a flavor pouch configured to store a flavor liquid, a compression mechanism configured to compress the flavor pouch, and an opening of the flavor pouch coupled to a valve. The beverage making assembly includes a plunger fluidically coupled to the valve through a cross-section of the outlet pipe. The beverage making assembly includes an actuator pivoted on the outlet pipe and operatively coupled to the plunger. The actuator is actuated to uncouple the plunger from the valve and the cross-section and allow dispersion of the flavor liquid in a predefined amount in water flowing through the cross-section, thereby making a beverage.

### TECHNICAL FIELD

This disclosure relates generally to the field of beverages, more particularly to an assembly for making beverages.

### BACKGROUND

Currently, households depend on fundamental water sources, such as water purifier taps or earthen clay pots, which only deliver plain water. This monotony may lead to a decline in the regular consumption of water. As a result, a significant number of individuals prefer beverages. The beverages are flavored liquids designed for human consumption, which effectively quench thirst. These beverages can be either carbonated or non-carbonated. Furthermore, the non-carbonated beverages can be prepared in domestic settings or obtained through packaged sources.

However, preparing non-carbonated beverages in the domestic settings such as at home may result in inconsistent taste. Additionally, preparing beverages at home requires manual measurement and mixing of flavored concentrates, which is both time-consuming and inconsistent. Moreover, flavoring an entire water reservoir compels users to maintain a single flavor, thereby limiting variety. In addition, numerous flavoring solutions necessitate electrical components or complex installations, rendering impracticality, particularly in regions with restricted resources.

Accordingly, there is a requirement for a solution to make a beverage by allowing flow of the flavor liquid within the water.

### SUMMARY

In an embodiment, a beverage making assembly is disclosed. The assembly may include a retractable-flavor storage. The retractable-flavor storage may include a flavor pouch configured to store a flavor liquid, a compression mechanism configured to compress the flavor pouch, and an opening of the flavor pouch coupled to a valve. The valve may be configured to be coupled to an outlet pipe of a water storage. The assembly may include a plunger fluidically coupled to the valve through a cross-section of the outlet pipe. Further, the plunger when coupled to the valve may be configured to restrict flow of the flavor liquid from the valve and restrict flow of water through the outlet pipe. Further, the assembly may include an actuator pivoted on the outlet pipe and operatively coupled to the plunger. The actuator may be actuated to uncouple the plunger from the valve and the cross-section and allow dispersion of the flavor liquid in a predefined amount in water flowing through the cross-section, thereby making a beverage.

In another embodiment, a water storage is disclosed. The water storage may include an outlet pipe and a beverage making assembly coupled to the outlet pipe. The assembly may include a retractable-flavor storage. The retractable-flavor storage may include a flavor pouch configured to store a flavor liquid, a compression mechanism configured to compress the flavor pouch, and an opening of the flavor pouch coupled to a valve. The valve may be configured to be coupled to an outlet pipe of a water storage. The assembly may include a plunger fluidically coupled to the valve through a cross-section of the outlet pipe. Further, the plunger when coupled to the valve may be configured to restrict flow of the flavor liquid from the valve and restrict flow of water through the outlet pipe. Further, the assembly may include an actuator pivoted on the outlet pipe and operatively coupled to the plunger. The actuator may be actuated to uncouple the plunger from the valve and the cross-section and allow dispersion of the flavor liquid in a predefined amount in water flowing through the cross-section, thereby making a beverage.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a perspective view of a water storage equipped with a beverage making assembly, in accordance with an embodiment of the present disclosure.

FIG. 2 illustrates a sectional view of the beverage making assembly, in accordance with an embodiment of the present disclosure.

FIG. 3 illustrates a front view of a flavor pouch, in accordance with an embodiment of the present disclosure.

FIG. 4 illustrates a top view of a valve, in accordance with an embodiment of the present disclosure.

FIG. 5 illustrates a first-sectional view of the beverage making assembly in an actuated state, in accordance with an embodiment of the present disclosure.

FIG. 6 illustrates a second-sectional view of the beverage making assembly in the actuated state, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises… a” does not, without more constraints, preclude the existence of other elements or additional elements in the system or apparatus.

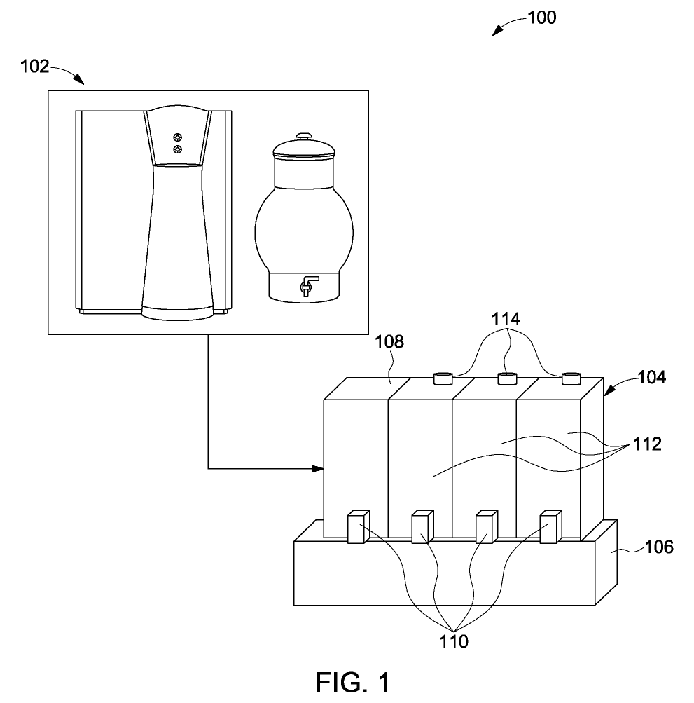

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-6.

As explained earlier, the making of beverages within domestic settings is often cost-prohibitive and not readily accessible. Further, manual making of the beverages is time-consuming and inconsistent in taste and flavors due to non-uniform mixing of flavor liquid with the water.

Therefore, a beverage making assembly is disclosed. The beverage making assembly may be configured to be retrofittable with the water storage such as water filters, and water pots. Further, the beverage making assembly may be configured to dispense flavor liquid into the water, thereby facilitating making of the beverage in a controlled ratio.

Referring to FIG. 1, a perspective view 100 of a water storage 102 equipped with a beverage making assembly 104 is illustrated, in accordance with an embodiment of the present disclosure. In an embodiment, the water storage 102 may be configured to store a predefined amount of water. By way of example, the water storage 102 may include but not limited to a water filter, a water pot, and the like. The water storage 102 may include a base 106 and a container 108 disposed on the base 106. The container 108 may be configured to store the water in the predefined amount. The water storage 102 may include a plurality of connectors (not shown in FIG. 1) and a plurality of hoses (not shown in FIG. 1) adjoined to the corresponding connectors. The hose from the plurality of hoses may be configured to connect the water storage 102 to the container 108, thereby allowing water to be received by the container 108. It is to be noted, the water storage 102 may be configured to receive water from a water supply (not shown) of a household.

The container 108 of the water storage 102 may include a valve (not shown) and an outlet pipe (not shown) coupled to the valve. The valve may be configured to allow the flow of water within the outlet pipe. Further, the outlet pipe may be configured to receive water from the container 108, and may define a cross-section (not shown) configured to allow flow of water within the outlet pipe. The outlet pipe may include a first intake (not shown) coupled to the container 108, a second intake (not shown in FIG. 1) disposed inline to the first intake, and an outlet (not shown) of the water storage 102. Accordingly, the water from the container 108 may flow through the cross section of the outlet pipe towards the outlet for consumption.

In an embodiment, the container 108 may include a knob 110 coupled to the valve, and may be configured to regulate a flow of water towards the cross section of the outlet pipe. Further, the container 108 may be coupled to a plurality of retractable-flavor storage 112 disposed on the base 106. Each retractable-flavor storage 112 may define an enclosure configured to accommodate a flavor pouch. The flavor pouch may be configured to store a flavor liquid. By way of example, the flavor liquid may include but not limited to a concentrated fruit-based syrup, a coffee concentrate, and the like. Further, each retractable-flavor storage 112 may include the valve configured to allow dispersion of the flavor liquid within the water flowing in the cross-section of the outlet pipe. For example, the flavor pouch may be retrofitted with the valve in an upside-down alignment to allow dispersion of the flavor liquid. Further, each retractable-flavor storage 112 may include an inlet port 114 configured to change or refill the flavor pouch. Further, each retractable-flavor storage 112 may include an indicator (not shown) configured to indicate an amount of flavor liquid available in the flavor pouch. By way of example, the indicator may be a transparent shield, or a plurality of level markings on a transparent section formed on an outer surface of the retractable-flavor storage 112. As explained earlier, the water flowing in the cross-section of the outlet pipe may be unflavored and the flavor liquid may be required to be dispersed within the cross-section.

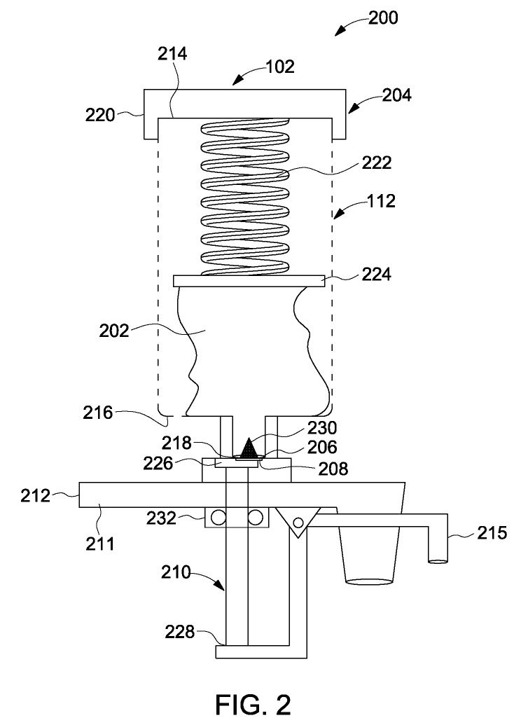

Therefore, the beverage making assembly 104 may be coupled to the outlet pipe of the water storage 102. The beverage making assembly 104 may be disposed with each retractable-flavor storage 112. The beverage making assembly 104 may be configured to disperse a predefined amount of the flavor liquid from the flavor pouch in the water flowing through the cross-section of the outlet pipe via the valve. The beverage making assembly 104 may be configured to make a beverage by regulating the flow of the flavor liquid within the water flowing in the cross-section. Additionally, the flow of the flavor liquid from the retractable-flavor storage 112 may be regulated by the knob 110. The operation of the beverage making assembly is explained in greater detail in conjunction with FIGS. 2-4.

Referring to FIG. 2, a sectional view 200 of the beverage making assembly 104 is illustrated, in accordance with an embodiment of the present disclosure. In an embodiment, and as explained earlier, the beverage making assembly 104 may include the retractable-flavor storage 112. The retractable-flavor storage 112 may include a flavor pouch 202 configured to store the flavor liquid, a compression mechanism 204 configured to compress the flavor pouch 202 and an opening 206 of the flavor pouch 202 coupled to a valve 208. The beverage making assembly 104 may include a plunger 210 fluidically coupled to the valve 208 through a cross-section 211 of an outlet pipe 212. The plunger 210 when coupled to the valve 208 may be configured to restrict flow of the flavor liquid from the valve 208 and restrict flow of water through the outlet pipe 212. Similarly, the plunger 210 when uncoupled to the valve 208 may be configured to enable flow of the flavor liquid from the valve 208 and allow flow of water through the outlet pipe 212. Further, the beverage making assembly 104 may include an actuator 215 pivoted on the outlet pipe 212 and operatively coupled to the plunger 210. The actuator 215 may be actuated to uncouple the plunger 210 from the valve 208 and the cross-section 211 and allow dispersion of the flavor liquid from the flavor pouch 202 in a predefined amount in the water flowing through the cross-section 211, thereby making a beverage.

To elaborate further, the retractable-flavor storage 112 may define the enclosure and the flavor pouch 202 may be accommodated within the enclosure in the upside-down alignment. The retractable-flavor storage 112 may include a top portion 214 and a bottom potion 216 disposed opposite to the top portion 214. The top portion 214 may be engaged to the compression mechanism 204, and the bottom portion 216 may be coupled to a second intake 218 of the outlet pipe 212. Further, the bottom portion 216 may be engaged to the flavor pouch 202. Accordingly, the flavor pouch 202 may be coupled to the second intake 218 of the opening 206. The second intake 218 may be a threaded intake and may include the valve 208. Particularly, the opening 206 of the flavor pouch 202 may be coupled to the valve 208. The opening 206 may be defined as a threaded opening, and may be formed corresponding to the threaded intake of the second intake 218. Accordingly, the flavor pouch 202 may be retrofitted to the opening 206 via the valve 208 in the upside-down alignment.

As explained earlier, the flavor pouch 202 may be compressed by the compression mechanism 204. The compression mechanism 204 may be disposed on the top portion 214 of the retractable-flavor storage 112 to compress the flavor pouch 202. By virtue of compression, the flavor liquid may tend to flow towards the opening 206. It is to be noted, the flavor liquid in the predefined amount may be released in response to the compression of the flavor pouch 202 by the compression mechanism 204. The assembly of the compression mechanism 204 may be explained in the greater details hereinafter.

In an embodiment, the compression mechanism 204 may include a cap 220 disposed on the top portion 214 of the retractable-flavor storage 112. Further, the cap 220 may be coupled to a biasing member 222. Further, the biasing member 222 may be suspended from the cap 220. Further, the biasing member 222 may include a low-tension helical spring. Further, a free end of the biasing member 222 may be coupled to a bar 224. The bar 224 may be positioned above the flavor pouch 202. Further, the extension of the biasing member 222 may be configured to exert a biasing force on the bar 224. Moreover, under the biasing force, the bar 224 may exert a biasing force constantly on the flavor pouch 202.

As a result, the flavor liquid may steadily flow from the flavor pouch 202 into the outlet pipe 212 when the plunger 210 may be uncoupled from the valve 208. The flavor liquid may possess a tendency to flow in a reverse direction, thus, the biasing force may be configured to prevent a backflow of the flavor liquid. Therefore, one-way flow dynamics of the flavor liquid may be maintained.

The flavor liquid may be dispersed to the opening 206 via the valve 208 when the plunger 210 may be uncoupled from the valve 208. The plunger 210 may be uncoupled in response to the actuation of the actuator 215. By way of example, the actuator 215 may be a pivoted lever. The assembly of the plunger 210 is explained in greater detail hereinafter.

In an embodiment, the plunger 210 may include a top end 226 and a bottom end 228 disposed opposite to the top end 226. The top end 226 may be coupled to the valve 208 and the bottom end 228 may be coupled to the actuator 215. Moreover, to allow flow of the flavor liquid from the flavor pouch 202, the top end 226 may be coupled to a needle 230 disposed within the valve 208. The needle 230 may be configured to pierce a membrane (not shown) of the opening 206 of the flavor pouch 202 when engaged to the second intake 218. Due to piercing of the membrane, the flow of the flavor liquid may be controlled from the flavor pouch 202 to the outlet pipe 212 via the valve 208. For example, when plunger 210 may be uncoupled, the flavor liquid may pass through the valve 208. Further, the plunger 210 may include a pair of O-rings 232 configured to restrict the leakage of the water and the flavor liquid flowing in the cross-section 211 of the outlet pipe 212. Additionally, the plunger 210 may be configured to move through the pair of O-rings 232 when actuated by the actuator 215.

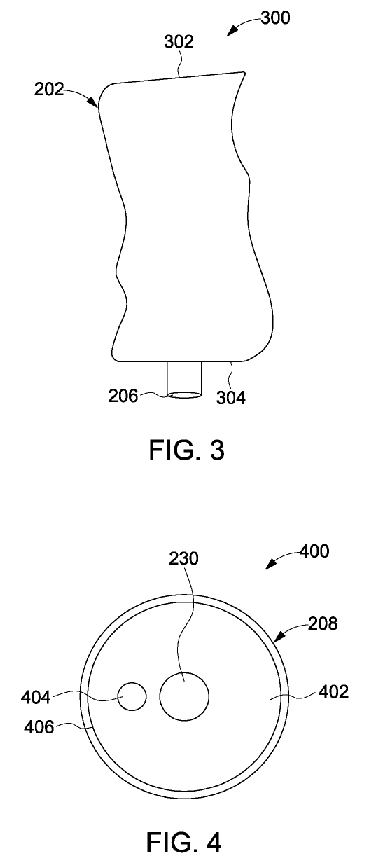

Referring to FIG. 3, a front view 300 of the flavor pouch 202 is illustrated, in accordance with an embodiment of the present disclosure. FIG. 3 is explained in conjunction with FIG. 2. As the name suggests, the flavor pouch 202 may be compressible and may be retrofitted with the outlet pipe 212 of the water storage 102. The flavor pouch 202 may include a top section 302 and a bottom section 304 disposed opposite to the top section 302. The top section 302 may be contacted to the bar 224 of the compression mechanism 204. The bottom section 304 may include the opening 206 configured to be engaged to the second intake 218 of the outlet pipe 212. Further, the top section 302 and the bottom section 304 may define a storage capacity for the fluid liquid of the flavor pouch 202. The fluid liquid may be dispersed into the outlet pipe 212 via the valve 208. The assembly of the valve 208 is explained in greater detail, hereinafter.

Referring to FIG. 4, a top view 400 of valve 208 is illustrated, in accordance with an embodiment of the present disclosure. By way of example, the valve 208 may be an orifice valve. The valve 208 may include an inlet 402, and an orifice 404 formed at the inlet 402 to allow flow of the flavor liquid into the outlet pipe 212 upon actuation of the valve 208. Further, the valve 208 may include a rotary opening lid 406 adjoined to the inlet 402. The rotary opening lid 406 may be rotated to adjust the position of the inlet 402 relative to an opening (not shown) formed in the outlet pipe 212. For example, when the inlet 402 may be in line to the opening, the flavor liquid may flow into the outlet pipe 212 through the inlet 402 and the at a maximum flow rate. In contrast, when the inlet 402 may be in partially line to the opening, the flavor liquid may flow into the outlet pipe 212 at a reduced flow rate. Moreover, when the inlet 402 may not be in line to the opening, the flavor liquid may not flow into the outlet pipe 212. This is explained in greater detail hereinafter.

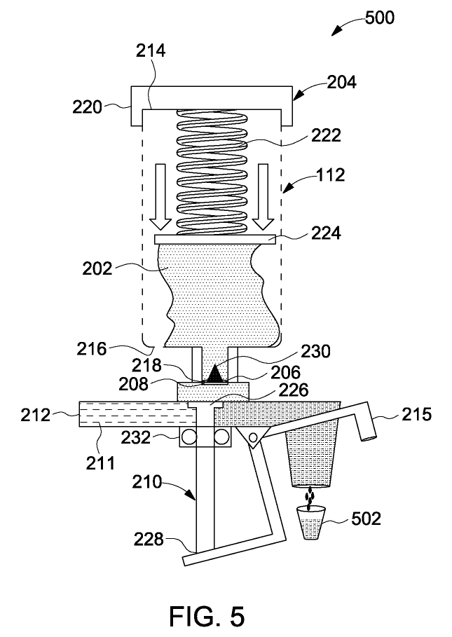

Referring to FIG. 5, a first-sectional view 500 of the beverage making assembly 104 in an actuated state is illustrated, in accordance with an embodiment of the present disclosure. As explained earlier, the beverage making assembly 104 may include the retractable-flavor storage 112. The retractable-flavor storage 112 may include the flavor pouch 202, the opening 206 of the flavor pouch 202 coupled to the valve 208, and the compression mechanism 204 may be disposed on the top section 302 of the flavor pouch 202. Further, the beverage making assembly 104 may include the plunger 210, and the actuator 215 pivoted on the outlet pipe 212 and operatively coupled to the plunger 210. Further, in the actuated state, the flavor liquid may flow through the outlet pipe 212 in response to the actuation of the actuator 215.

In an embodiment, the actuator 215 may be any one of manually operated or actuated with an actuator 215. As apparent from FIG. 5, the actuator may be manually operated. By way of example, the actuator may be a lever. When the actuator 215 is actuated manually, i.e., by a user, the plunger 210 may be uncoupled from the valve 208 and the cross-section 211 of the outlet pipe 212. Moreover, the biasing force exerted by the biasing member 222 and the bar 224 on the flavor pouch 202 may enable the flow of the flavor fluid from the flavor pouch 202 to the cross section of the outlet pipe 212 through the inlet 402 of the valve 208. Accordingly, the flavor liquid in the predefined amount may be dispersed in the water flowing through the cross-section 211 of the outlet pipe 212 and the beverage may be made. The beverage made may be poured into a receptacle 502 such as tumbler, glass, and the like, for consumption.

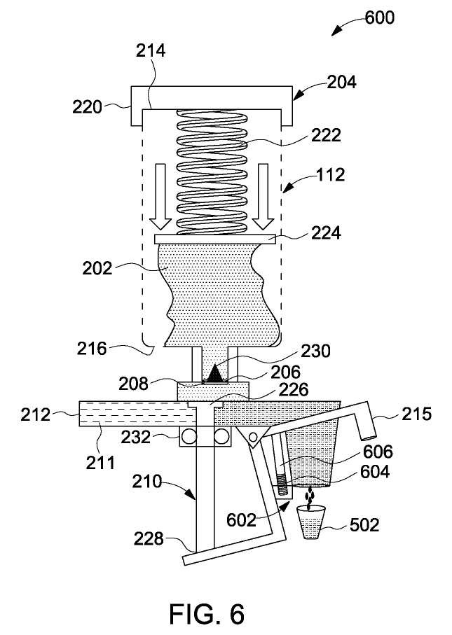

Referring to FIG. 6, a second-sectional view 600 of the beverage making assembly 104 in the actuated state is illustrated, in accordance with an embodiment of the present disclosure. In another embodiment, the actuator 215 may be actuated by the actuator. By way of example, the actuator 215 may be the lever and a solenoid-based actuator 602 coupled to the lever. For example, the solenoid-based actuator 602 may be IOT (Internet of Things)-based solenoid actuator 602, and may be communicably coupled to, and operated by a user-device. For example, the solenoid-based actuator 602 may include a coil 604 such as a solenoid, and a moveable core 606 such as a metal plunger engaged to the coil 604. Upon receipt of an input command from the user-device, the moveable core 606 may actuate the lever in a vertically downward direction to uncouple the plunger 210 from the valve 208 and the cross-section 211. In response, a passage may be created through the valve 208, and the flavor liquid may flow into the water flowing through the cross-section 211 of the outlet pipe 212, thereby making the beverage and pouring the beverage into the receptacle 502. The making of the beverage is already explained in FIGS. 1-5.

As will be appreciated by those skilled in the art, the beverage making assembly described in the various embodiments discussed above are not routine, or conventional or well understood in the art. The beverage making assembly discussed above may be capable of offering several advantages. The beverage making assembly may be retrofitted in the water storages, such as water pots, water filters. Therefore, the beverage making assembly may be utilized in households, cafes, public spaces and the beverages of desired flavor may be obtained without requirement of skilled operator.

Further, the beverage making assembly may be capable of making beverage by mixing the flavor liquid in the water flowing through the cross-section of the outlet pipe in the predefined amount. Additionally, the flow of the fluid liquid may be regulated from the valve. Therefore, the beverage making assembly simplifies water flavoring, enhances user convenience, and encourages healthier hydration habits. Thus, the disclosed assembly try to overcome the technical problem of making the beverage.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A beverage making assembly comprising:
a retractable-flavor storage, comprising:
a flavor pouch configured to store a flavor liquid;
a compression mechanism configured to compress the flavor pouch;
an opening of the flavor pouch coupled to a valve, wherein the valve is configured to be coupled to an outlet pipe of a water storage;
a plunger fluidically coupled to the valve through a cross-section of the outlet pipe , wherein the plunger when coupled to the valve is configured to restrict flow of the flavor liquid from the valve and restrict flow of water through the outlet pipe; and
an actuator pivoted on the outlet pipe and operatively coupled to the plunger, wherein the actuator is actuated to uncouple the plunger from the valve and the cross-section and allow dispersion of the flavor liquid in a predefined amount in water flowing through the cross-section, thereby making a beverage.

2. The beverage making assembly of claim 1, wherein the flavor liquid in the predefined amount is released in response to the flavor pouch compressed by the compression mechanism.

3. The beverage making assembly of claim 2, wherein the compression mechanism comprises:
a cap disposed on a top portion of the retractable-flavor storage;
a biasing member suspended from the cap; and
a bar coupled to a free end of the biasing member and in contact with the flavor pouch, wherein the bar is configured to compress the flavor pouch under a biasing force exerted by the biasing member.

4. The beverage making assembly of claim 1, wherein the valve comprises:
an inlet;
an orifice formed at the inlet of the valve to allow flow of the flavor liquid from the inlet; and
a rotary opening lid adjoined to the inlet, wherein the rotary opening lid is rotated to allow a flow of flavor liquid from the flavor pouch into the outlet pipe during uncoupling of the plunger.

5. The beverage making assembly of claim 4, wherein the plunger is coupled to a needle, wherein the needle is configured to pierce a membrane of the opening of the flavor pouch and configured to control the flow of the flavor liquid from the flavor pouch to the outlet pipe via the valve.

6. The beverage making assembly of claim 1, wherein the actuator is any one of:
manually actuated, or
actuated with an actuator.

7. A water storage, comprising:
an outlet pipe; and
a beverage making assembly coupled to the outlet pipe, the assembly comprising:
a retractable-flavor storage, comprising:
a flavor pouch configured to store a flavor liquid;
a compression mechanism configured to compress the flavor pouch;
an opening of the flavor pouch coupled to a valve, wherein the valve is configured to be coupled to the outlet pipe of the water storage;
a plunger fluidically coupled to the valve through a cross-section of the outlet pipe, wherein the plunger when coupled to the valve is configured to restrict flow of the flavor liquid from the valve and restrict flow of water through the outlet pipe; and
an actuator pivoted on the outlet pipe and operatively coupled to the
plunger, wherein the actuator is actuated to uncouple the plunger from the valve and the cross-section and allow dispersion of the flavor liquid in a predefined amount in water flowing through the cross-section, thereby making a beverage.

8. The water storage of claim 7, wherein the flavor liquid in the predefined amount is released in response to the flavor pouch compressed by the compression mechanism.

9. The water storage of claim 7, wherein the valve comprises:
a cap coupled to a top portion of the retractable-flavor storage;
a biasing member suspended from the cap; and
a bar coupled to a free end of the biasing member and in contact with the retractable-flavor storage, wherein the bar is configured to compress the flavor pouch under a biasing force exerted by the biasing member.

10. The water storage of claim 7, wherein the valve comprises:
an inlet;
an orifice formed at the inlet of the valve to allow flow of the flavor liquid from the inlet; and
a rotary opening lid adjoined to the inlet, wherein the rotary opening lid is rotated to allow a flow of flavor liquid from the flavor pouch into the outlet pipe during uncoupling of the plunger.

11. The water storage of claim 10, wherein the plunger is coupled to a needle, wherein the needle is configured to pierce a membrane of the opening of the flavor pouch and configured to control the flow of the flavor liquid from the flavor pouch to the outlet pipe via the valve.

12. The water storage of claim 7, wherein the actuator is any one of:
manually actuated, or
actuated with an actuator.
